(19) United States
(12) Patent Application Publication
(10) Pub. No.: US 2009/0086597 A1
(43) Pub. Date: Apr. 2, 2009

(54) OPTICAL DISC APPARATUS AND OPTICAL DISC RECORDING METHOD

(75) Inventors: Hirokazu Shou, Tokyo (JP); Nobuyuki Baba, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/239,036

(22) Filed: Sep. 26, 2008

(30) Foreign Application Priority Data
Sep. 28, 2007 (JP) 2007-254781

(51) Int. Cl. G11B 5/00

(52) U.S. Cl. 369/47.53; G9B/5

(57) ABSTRACT

Provided is an optical disc apparatus including: an optical pickup configured to form marks and spaces on the optical disc by using a recording power and a erasing power respectively; a control unit configured to write test data on trial on the optical disc while changing the recording power and the erasing power and to determine an optimum recording power and an optimum erasing power; and a nonvolatile memory configured to store a correction coefficient which has been obtained in advance. The control unit corrects a power ratio of a recommended recording power to a recommended erasing power by the correction coefficient stored in the memory, and controls to write the test data on trial on the optical disc while changing the recording power and a erasing power, the erasing power being acquired from the recording power and the corrected power ratio.

### CROSS-REFERENCE TO RELATED APPLICATIONS

This application claims the benefit of priority of Japanese Patent Application No. 2007-254781, filed Sep. 28, 2007, the entire contents of which are incorporated herein by reference.

### BACKGROUND

1. Field

The present invention relates to an optical disc apparatus and an optical disc recording method. In particular, the invention relates to an optical disc apparatus of performing recording and reproduction on a rewritable type optical disc and an optical disc recording method of performing recording on a rewritable type optical disc.

2. Description of the Related Art

In rewritable type optical discs such as DVD-RWs, DVD+RWs, HD DVD-RWs, HD DVD-RAMs and others, overwriting of new data can be performed by irradiating a recording face on which data has already been recorded with laser light for recording from above the recording face. The power of the laser light for recording used for forming a mark is different from the power used for forming a space. A recording power Pw used for forming the mark is larger than a erasing power Pe used for forming the space.

In general, in a rewritable type optical disc, optimum recording power Pw and optimum erasing power Pe differ for different optical discs or different optical disc manufacturers. In each optical disc, identification information of the manufacturer thereof and information on recording power Pw and erasing power Pe recommended by the manufacturer thereof are recorded.

The power of laser light of an optical disc apparatus varies depending on the environmental conditions such as the temperature around the apparatus. Therefore, even if it is intended to set the recording power Pw and the erasing power Pe recommended by the manufacturer thereof, it is not always possible to set these powers as recommended.

Accordingly, in the optical disc apparatus, in a case that recording is to be performed on an optical disc inserted into the apparatus, usually, a laser power optimizing process which is referred to as OPC (Optimum Power Control) is performed immediately before the recording.

The procedures of a generally conducted OPC are, for example, as follows. First, in a state that a ratio ε of a manufacturer-recommended recording power Pw to a manufacturer-recommended erasing power Pe (ε=the erasing power Pe/the recording power Pw) is maintained constant, while changing the recording power Pw, for example, stepwise, test data is recorded in a predetermined area of an optical disc. Next, the recorded test data is reproduced from the optical disc and an evaluation index such as the degree of modulation is acquired from a reproduction signal thereof. This evaluation index is acquired for each recording power Pw which has been changed upon test data recording. The evaluation index for each recording power Pw is compared with an evaluation index reference which is separately defined and a recording power Pw corresponding to the evaluation index which meets the evaluation index reference is determined as an optimum recording power Pwopt. Then, an optimum erasing power Peopt is determined from the optimum recording power Pwopt and the above mentioned ratio ε.

In this generally conducted OPC, in the recording power Pw and the erasing power Pe which are originally independent parameters, only the recording power Pw is changed to acquire an optimum value. While, as for the erasing power Pe, the ratio ε defined from the value recommended by the manufacturer of the optical disc concerned is utilized to acquire its optimum value. However, actually, the ratio ε varies also under the influence of the characteristics of the optical disc apparatus.

For example, upon recording, a plurality of laser short pulses of lengths on the order of 5 ns-10 ns are used. However, these short pulses have overshoots and the magnitude of the overshoot is varied depending on a constant of an equivalent circuit used of a transmission system concerned. Therefore, a laser power is slightly different from one another depending on individual optical disc apparatuses. The influence of the overshoot on the recording power Pw is different from that on the erasing power Pe and hence it cannot be said that the method of acquiring the optimum value of the erasing power Pe from the ratio ε defined from the value recommended by the manufacturer of the optical disc concerned is absolutely perfect. In addition, the individual optical disc apparatuses slightly differ from one another also in characteristics of their optical systems, resulting in different size of their laser spots.

As described above, in the conventionally conducted general type OPC, although the time required for processing is relatively shortened, it cannot be said that the value obtained is always optimum in the strict sense of the word. That is, the recording power Pw and the erasing power Pe which are obtained by the conventionally conducted general type OPC are of values which should be rather called quasi-optimum values in short. Strictly speaking, these quasi-optimum values do not coincide with genuine optimum recording power Pwopt and genuine optimum erasing power Peopt, respectively.

It is generally known that when overwriting is performed by using the genuine optimum recording power Pwopt and the genuine optimum erasing power Peopt, the maximum number of allowed overwriting operations can be obtained. The more the powers Pw and Pe differ from the genuine optimum recording power Pwopt and the genuine optimum erasing power Peopt, the more is the number of allowed overwriting operations on an optical disc concerned reduced, that is, the more is the life of the optical disc reduced.

Therefore, there has been conventionally proposed a technique for trying to bring the recording power Pw and the erasing power Pe closer to the genuine optimum recording power Pwopt and the genuine optimum erasing power Peopt by performing a more strict OPC, for example, as disclosed in JP-A 2006-344251.

However, in the OPC disclosed in JP-A 2006-344251, the time required for processing is increased. In the technique disclosed therein, the OPC is conducted through the procedures, for example, as follows. As the first stage, the above mentioned ordinary general type OPC is performed in a state that a ratio ε of an optical disc manufacturer recommended recording power Pw to an optical disc manufacturer recommended erasing power Pe (ε=the erasing power Pe/the recording power Pw) is fixed. In this stage, an optimum recording power Pwopt is determined and a provisional erasing power Pe is acquired from the ratio ε. As the second stage, test recording is performed by using the determined optimum recording power Pwopt and the provisional erasing power Pe. Finally, as the third stage, overwriting is performed on an area on which the test recording has been performed in the second stage. In the third stage, the overwriting is performed while changing the ratio ε, that is, changing the erasing power Pe in a state that the optimum recording power Pwopt is fixed. Then, the data overwritten in the third stage is reproduced and evaluated to determine an optimum erasing power Peopt.

The OPC disclosed in JP-A 2006-344251 is a method in which the recording power Pw and the erasing power Pe are changed independently of each other to determine the optimum recording power Pwopt and the optimum erasing power Peopt, and hence there can be obtained powers closer to the genuine optimum recording power Pwopt and the genuine optimum erasing power Peopt than the ever obtained powers. However, the OPC method disclosed in JP-A 2006-344251 needs the recording operation in the second stage and the recording and reproducing operations in the third stage. On the other hand, the conventionally conducted general type OPC operation is needed only in the first stage. As a result, the OPC method disclosed in JP-A 2006-344251 requires considerably much time to determine the optimum recording power Pwopt and the optimum erasing power Peopt.

### SUMMARY OF THE INVENTION

Accordingly, the present invention has been made in view of the above-mentioned circumstances, and it is an object of the present invention to provide an optical disc apparatus and an optical disc recording method in which, while maintaining the time required for the OPC operation as short as the conventionally attained time, there can be obtained optimum recording power Pwopt and optimum erasing power Peopt which make it possible to realize an overwriting characteristic which is more favorable than the conventionally attained one.

In order to solve the above-mentioned problem, according to one aspect of the present invention, there is provided an optical disc apparatus which performs data recording and reproduction on a rewritable type optical disc. The optical disc apparatus includes: an optical pickup configured to form marks and spaces on the optical disc by using a recording power and a erasing power respectively, thereby to record data and to reproduce the recorded data; a control unit configured to write test data on trial on the optical disc while changing the recording power and the erasing power and to reproduce and evaluate the written test data, thereby to determine an optimum recording power and an optimum erasing power; and a nonvolatile memory configured to store a correction coefficient which has been obtained in advance. The control unit corrects a power ratio of a recommended recording power to a recommended erasing power, these powers being assigned to each optical disc as recommended values, by the correction coefficient stored in the memory, and controls to write the test data on trial on the optical disc while changing the recording power and a erasing power, the erasing power being acquired from the recording power and the corrected power ratio.

In addition, in order to solve the above-mentioned problem, according to another aspect of the present invention, there is provided an optical disc recording method of performing recording on a rewritable type optical disc, the method including the steps of: (a) obtaining, in advance, a correction coefficient and storing the obtained correction coefficient; (b) forming marks and spaces on the optical disc by using a recording power and a erasing power, thereby to record data on the optical disc, and reproducing the recorded data from the optical disc; and (c) writing test data on trial on the optical disc while changing the recording power and the erasing power, and reproducing and evaluating the written test data to determine an optimum recording power and an optimum erasing power. The step (c) comprises; correcting a power ratio of a recommended recording power to a recommended erasing power, these powers being assigned to each optical disc as recommended values, by the correction coefficient; and controlling to write the test data on trial on the optical disc while changing the recording power and a erasing power, the erasing power being acquired from the recording power and the corrected power ratio.

In the optical disc apparatus and the optical disc recording method according to the aspects of the present invention, there can be obtained optimum recording power Pwopt and optimum erasing power Peopt which make it possible to realize an overwriting characteristic which is more favorable than the conventionally attained one, while maintaining the time required for the OPC operation as short as the conventionally attained time.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a configuration example of an optical disc apparatus according to an embodiment of the present invention;

FIGS. 2A to 2C are diagrams schematically showing relations between laser powers (a recording power Pw and a erasing power Pe) and marks and spaces in a rewritable type optical disc;

FIG. 3 is a diagram illustrating the concept of a conventionally conducted general type OPC;

FIG. 4 is a diagram illustrating problems of the conventionally conducted general type OPC;

FIG. 5 is a flowchart showing one example of a laser power optimizing process according to the embodiment of the present invention;

FIGS. 6A to 6C are diagrams showing the operational concepts of the laser power optimizing process according to the embodiment of the present invention;

FIG. 7 is a flowchart showing one example of a correction coefficient Ko obtaining method according to the embodiment of the present invention;

FIGS. 8A to 8D are diagrams showing the concepts of the correction coefficient Ko obtaining method according to the embodiment of the present invention;

FIGS. 9A to 9C are illustrations of a correction coefficient K (t_{d}) to which a change in temperature is added; and

FIG. 10 is a flowchart showing an example of a laser power optimizing process using the correction coefficient K (t_{d}).

### DETAILED DESCRIPTION

Embodiments of an optical disc apparatus and an optical disc recording method according to the present invention will be described with reference to the accompanying drawings.

### (1) Configuration And Overall Operation of Optical Disc Apparatus

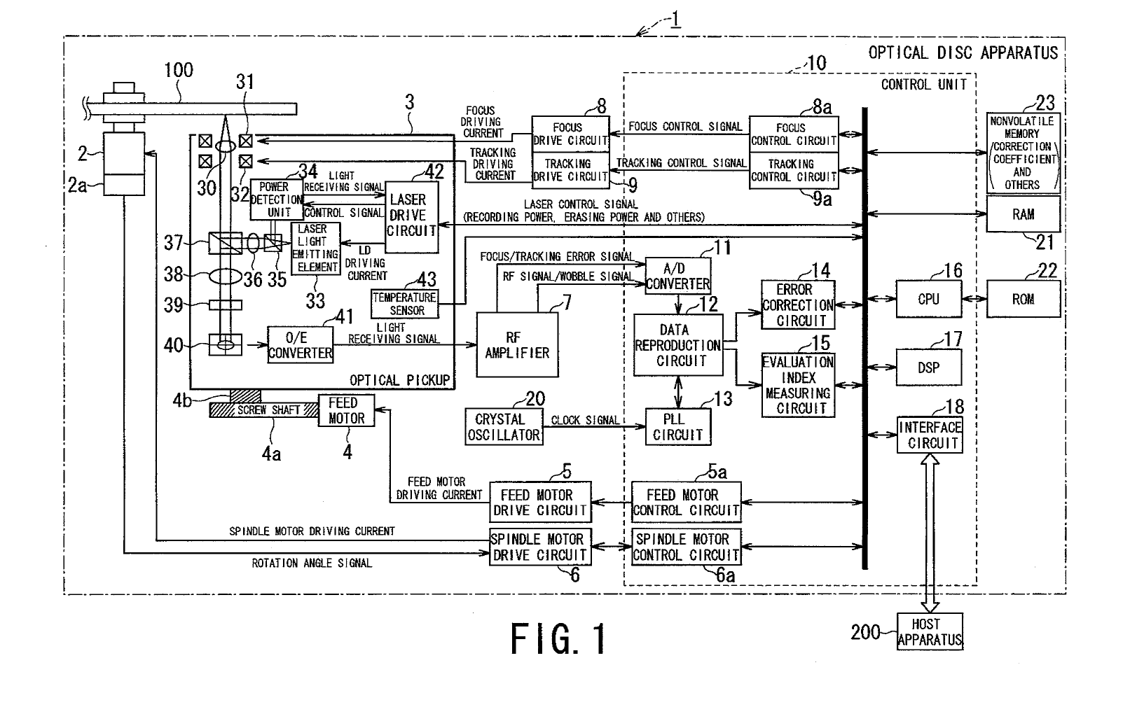

FIG. 1 illustrates a configuration example of an optical disc apparatus 1 according to an embodiment of the present invention.

The optical disc apparatus 1 is configured to perform recording and reproduction of information on a rewritable type optical disc 100 such as a DSVD-RW, a DVD+RW, a DVD-RAM, a HD DVD-RW, a HD DVD-RAM or the like. In the optical disc 100, a channel is carved spirally. A concave part of the channel is called a “groove” and a convex part thereof is called a “land”. One circle of the groove or the land is called a “track”. User data is recorded in the optical disc 100 along this track (only the groove, or the groove and the land) by forming marks and spaces on the track through irradiation with intensity-modulated laser light. In recording the user data, the user data can be overwritten on previously recorded data. The user data is overwritten by using a recording power Pw when a mark is to be newly formed and by using a erasing power Pe which is smaller than the recording power Pw when a space is to be formed.

Reproduction of the data is performed by detecting changes in intensity of light reflected from the marks and spaces on the track through irradiation along the track with laser light having a reading power which is smaller than a laser power during the recording.

The optical disc 100 is rotated and driven by a spindle motor 2. A rotation angle signal is output from a rotary encoder 2a provided on the spindle motor 2. The rotation angle signal is composed of a plurality of pulse signals generated, for example, every time the spindle motor 2 makes one revolution. From this rotation angle signal, it is possible to determine the rotation angle and the number of revolutions of the spindle motor 2. The rotation angle and the number of revolutions of the spindle motor 2 are input into a spindle motor control circuit 6a via a spindle motor drive circuit 6. The spindle motor control circuit 6a controls rotation and driving of the spindle motor 2 on the basis of these pieces of information. A drive control signal is converted to a spindle motor driving current by the spindle motor drive circuit 6 and then is input into the spindle motor 2.

Recording and reproduction of information is performed on the optical disc 100 by an optical pickup 3. The optical pickup 3 is coupled to a feed motor 4 via a gear 4b and a screw shaft 4a. The feed motor 4 is controlled by a feed motor control circuit 5a via a feed motor drive circuit 5. As the feed motor 4 is rotated with a feed motor driving current supplied from the feed motor drive circuit 5, the optical pickup 3 is moved in a radius direction of the optical disc 100.

In the optical pickup 3, there is provided an objective lens 30 supported by a wire or a leaf spring not shown in the drawing. The objective lens 30 is allowed to move in a focusing direction (an optical axis direction of the lens) by driving of a drive coil 31. Also, the objective lens 30 is allowed to move in a tracking direction (a direction orthogonal to the optical axis direction of the lens) by driving of a drive coil 32.

A laser drive circuit 42 supplies a laser diode driving current for recording to a laser light emitting element (a laser diode) 33 on the basis of a laser control signal output from a control unit 10. Into the control unit 10, there is input user data for recording from a host apparatus 200 such as a personal computer or the like via an I/F circuit 18. The control unit 10 modulates the user data for recording by a modulation method such as an ETM (Eight to Twelve Modulation) method or the like to generate a laser control signal for forming marks and spaces. In addition, the control unit 10 performs a process of optimizing a recording power Pw for forming the marks and a process of optimizing a erasing power Pe for forming the spaces, prior to recording of the user data. These processes will be specifically described later. Recording of the user data is performed by using the optimized recording power Pw and erasing power Pe.

The laser drive circuit 42 also supplies a driving current for reading which is smaller than the driving current for writing to the laser light emitting element 33 during information reading.

A power detection unit 34, which includes a photo diode or the like, is configured to detect a signal in proportion to a quantity of light, that is, a light emission power, as a light receiving signal, based on a divided part of the laser light emitted from the laser light emitting element 33 with the use of a half mirror 35 at a given ratio configured to. The detected light receiving signal is supplied to the laser drive circuit 42. The laser drive circuit 42 controls the laser light emitting element 33 on the basis of the light receiving signal from the power detection unit 34 such that the light is emitted by using the recording power Pw, the erasing power Pe, and a reproducing power Pr, each power being set by the control unit 10.

During the recording, the laser light emitted from the laser light emitting element 33 passes through a collimator lens 36, a half prism 37 and the objective lens 30 and irradiates the optical disc 100, and then forms the marks and the spaces on the track of the optical disc 100.

On the other hand, during reproduction, light reflected from the optical disc 100 is guided to a light detector 40 via the objective lens 30, the half prism 37, a focusing lens 38, and a cylindrical lens 39. The light detector 40 is composed, for example, of four-partitioned light detection cells. Detection signals from these light detection cells are converted to analog electric signals by an O/E converter unit 41 which is integrated with the light detector 40 and are output to an RF amplifier 64.

The RF amplifier 64 processes the detection signals from the light detection cells to generate a focus error signal FE indicative of an error from a just focused point, a tracking error signal TE indicative of an error between the beam spot center of the laser light and the center of the track, an RF signal which is a full addition signal of the light detection cell signals, and a wobbling signal for reproducing a wobbled wave form of the track.

The focus error signal FE is subjected to a digital operational processing by a DSP 17 of the control unit 10 and then is supplied to a focus control circuit 8a. The focus control circuit 8a generates a focus control signal in accordance with the focus error signal FE. The generated focus control signal is converted to a focus driving current by a focus drive circuit 8 and is then supplied to the drive coil 31 in the focusing direction. As a result, there is performed focus servo control in which the laser light is regularly just-focused on a recording layer prepared on the optical disc 100.

On the other hand, the tracking error signal TE is subjected to a digital operational processing by the DSP 17 of the control unit 10 and then is supplied to a tracking control circuit 9a. The tracking control circuit 9a generates a tracking drive signal in accordance with the tracking error signal TE. The tracking control signal is converted to a tracking driving current by a tracking drive circuit 9 and then is supplied to the drive coil 32 in the tracking direction. As a result, there is performed tracking servo control in which the laser light regularly traces the track formed on the optical disc 100.

Execution of the focus servo control and the tracking servo control allows the focal point of the laser light to follow the track on the optical disc recording surface with high accuracy. As a result, the full addition signal RF which is the reproduction signal of the optical disc 100 correctly reflects intensity changes of light reflected from the marks and the spaces formed on the track on the optical disc 100 corresponding to the recorded information and hence it becomes possible to obtain the reproduction signal of high quality.

This reproduction signal is input into an AD converter 11, in which, then, the signal is converted into a digital reproduction signal and is supplied to a data reproduction circuit 12. From a PLL circuit 13, there is generated a reproduction clock on the basis of a clock signal output from a crystal oscillator 20 and the reproduction data output from the data reproduction circuit 12, resulting in that the reproduction clock in synchronism with a channel bit of reproduction data is obtained. Using this reproduction clock, sampling is performed by the AD converter 11.

The digital reproduction signal is binary-coded by the data reproduction circuit 12 and is demodulated to the reproduction data by a demodulation method corresponding to the modulation method conducted upon the recording. The reproduction data is then input into an error correction circuit 14 to be subjected to an error correcting process therein and is then output to the host apparatus 200 via the I/F circuit 18.

Into an evaluation index measuring circuit 15, the binary-coded data and an amplitude value of the digital reproduction signal output from the data reproduction circuit 12 is input. In the evaluation index measuring circuit 15, an evaluation index for determining optimum recording power Pwopt and optimum erasing power Peopt is measured and calculated. In this embodiment, as a method of optimizing the laser power, a γ method using a generally called parameter γ (see JP-A 2006-344251) is utilized. This parameter γ is measured and calculated by the evaluation index measuring circuit 15. This γ method is of the type that, first, the test data is recorded while changing the laser power upon test recording, next, the parameter γ is acquired from the amplitude value of the reproduction signal of the recorded test data, and then a recording power Pw and a erasing power Pe with which the acquired parameter γ corresponds to a predetermined value are determined as optimum values.

The CPU 16 and the DSP (Digital Signal Processor) 17 in the control unit 10 are processors configured to wholly control the optical disc apparatus 1 and to execute various operational processes. Into a ROM 22, programs of these processors are stored, and a RAM 21 functions as a working area or the like of these processors.

In a nonvolatile memory 23, there are stored correction coefficients and the like used in a laser power optimizing process according to this embodiment. How to obtain the correction coefficients and how to use the correction coefficients will be described later.

### (2) Laser Power Optimizing Process Executed Upon Recording

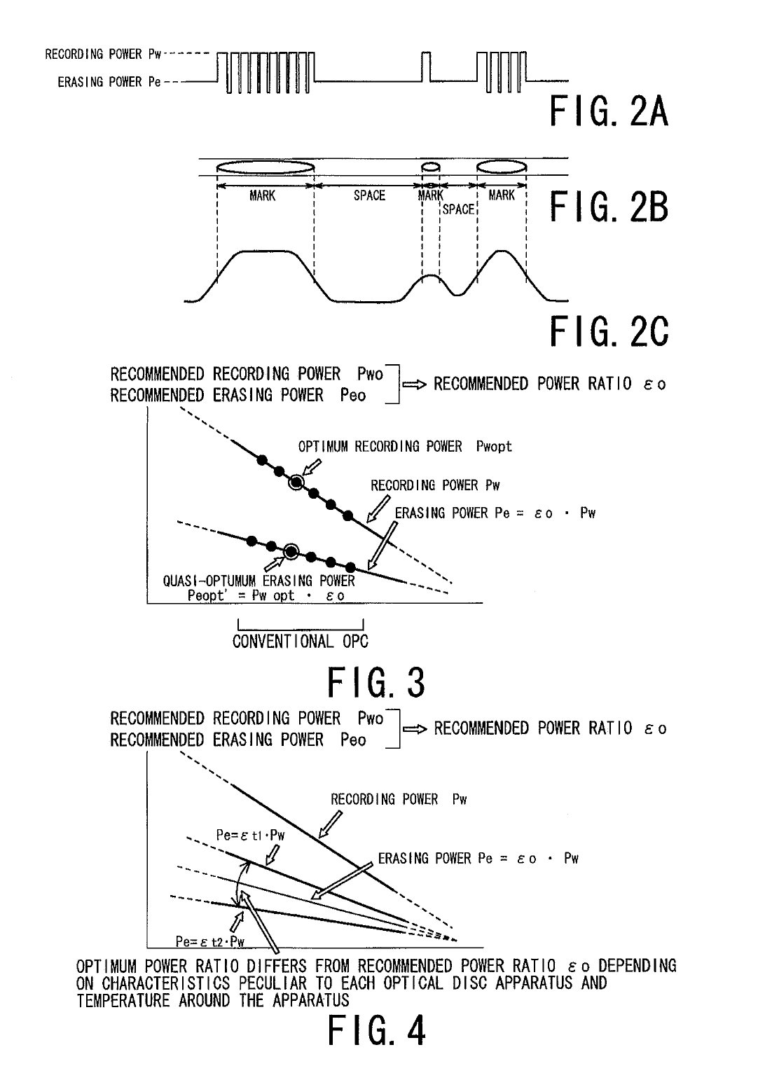

Next, a laser power optimizing process to be executed upon recording will be described. FIGS. 2A, 2B and 2C are diagrams schematically showing a laser wave form output from the laser light emitting element 33 upon recording (FIG. 2A), marks and spaces formed on the track of the optical disc 100 responding to the wave form in FIG. 2A (FIG. 2B) and a reproduction signal of these marks and spaces (FIG. 2C).

Usually, when a mark is to be formed (or overwritten), a multi-pulse as exemplified in FIG. 2A is used. The multi-pulse is composed of a plurality of pulses, a peak value of each being represented by a recording power Pw. On the other hand, when a space is to be formed (or overwritten), a erasing power Pe which is smaller than the recording power Pw is used.

In general, optimum recording power Pw and erasing power Pe differ for different types of optical discs used and different manufacturers thereof. Therefore, the recording power Pw and erasing power Pe recommended by a manufacturer of an optical disc concerned have been recorded, in advance, in a predetermined area of the optical disc concerned, together with identification information of its manufacturer.

However, the laser power output from the optical pickup 3 varies depending on the characteristic peculiar to each laser light emitting element 33 used and environmental conditions such as the surrounding temperature and the like. Therefore, as described above, the laser power optimizing process has been conventionally performed by the OPC.

In FIG. 3, concept of a general type OPC which has been conventionally conducted is illustrated for the propose of comparison with the present embodiments.

In the conventional OPC, in a state that a power ratio εo (εo=Pe/Pw) of the recording power Pw to the erasing power Pe is maintained constant, by changing stepwise the recording power Pw and the erasing power Pe, test data is recorded in a test area of the optical disc 100. Here, the power ratio so implies a recommended power ratio εo acquired from the recording power Pw and the erasing power Pe recommended by the optical disc manufacturer concerned.

The recorded test data is reproduced and a predetermined evaluation index, for example, the parameter γ is acquired from a reproduction signal of the test data for each recording power Pw and for each erasing power Pe. Then, the recording power Pw and the erasing power Pe corresponding to the parameter γ which meets a predetermined evaluation reference are determined as an optimum recording power Pwopt and an optimum erasing power Peopt.

However, in strictly speaking, the conventional OPC does not determine the optimum recording power Pw (and the optimum erasing power Pe). FIG. 4 is a diagram illustrating the reason for this fact.

In the conventional OPC, although the recording power Pw is changed stepwise in a predetermined range, the erasing power Pe is determined on the basis of the power ratio εo recommended by the disc manufacturer concerned. However, actually, the power ratio (hereinafter, referred to as an optimum power ratio) of the optimum recording power Pw to the optimum erasing power Pe does not become constant, but gives a value which varies depending on variation in characteristic peculiar to each optical disc apparatus 1 and the temperature around the apparatus. For example, as shown in FIG. 4, the value varies in a range from εₜ₁ to εₜ₂. The reason why the optimum power ratio differs from the power ratio εo recommended by the disc manufacturer mainly lies in a factor on the side of the optical disc apparatus 1. That is, as described above, the reason lies in that the influence of overshoot of the multi-pulse wave form, the characteristic of the optical system used and the like differ for different optical disc apparatuses 1. In addition, the influence of the overshoot and the characteristic of the optical system also vary depending on the temperature around the apparatus. The disc manufacturer cannot obtain information on these variation factors and hence these factors cannot be incorporated into determination of the power ratio εo recommended by the disc manufacturer.

However, considering from an opposite viewpoint, the above mentioned matter suggests that if a characteristic which is different for different optical disc apparatus 1 is obtained for each apparatus and the recommended power ratio εo can be corrected in accordance with a correction coefficient defined for each apparatus on the basis of data obtained for each apparatus, resulting in that a laser power optimizing process into which the above mentioned variation factors are incorporated can be realized. The optical disc apparatus 1 according to the embodiment of the present invention adopts a technique embodying this suggestion.

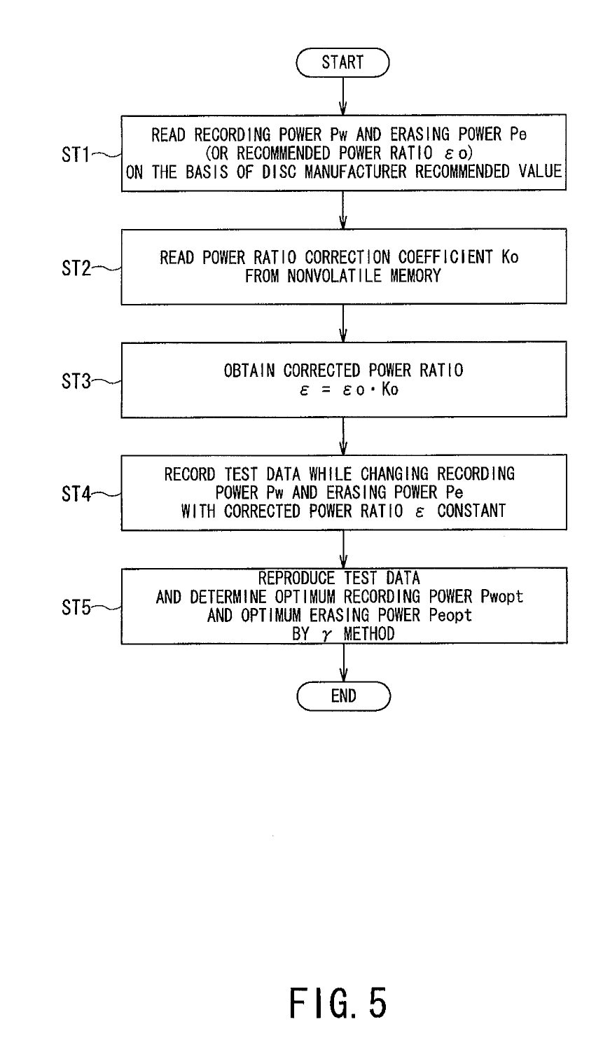

FIG. 5 is a flowchart showing an example of a laser power optimizing process in the optical disc apparatus 1 according to the embodiment of the present invention.

When the optical disc 100 is inserted into the optical disc apparatus 1 and an instruction to record user data is output from the host apparatus 200, the optimizing process shown in FIG. 5 will be performed prior to recording of the user data to determine the optimum recording power Pwopt and the optimum erasing power Peopt.

First, the recording power Pw and the erasing power Pe recommended by the disc manufacturer concerned are read out from the predetermined area of the inserted optical disc 100 to acquire the recommended power ratio εo (a step ST1).

Incidentally, once the name of the disc manufacturer and the type of the optical disc 100 are known, the recommended power ratio εo can be determined substantially uniquely. Thus, alternatively, a recommended power ratio εo which is related to the name of the disc manufacturer and the type of the optical disc 100 may be stored, in advance, in the nonvolatile memory 23, the name of the disc manufacturer and the type of the optical disc 100 may be read out from the inserted optical disc 100, and then the recommended power ratio εo corresponding thereto may be read out from the nonvolatile memory 23.

Next, a correction coefficient Ko of the power ratio which has been stored, in advance, in the nonvolatile memory 23 is read out (a step ST2). The correction coefficient Ko is obtained for each optical disc apparatus 1 in the course of manufacturing of each optical disc apparatus 1 and hence may have a value which is different for different apparatus.

At a step ST3, a power ratio ε which has been corrected is acquired from the recommended power ratio εo and the correction coefficient Ko (ε=εo·Ko).

At steps ST4 and ST5, processes are basically the same as those in the conventionally conducted OPC. That is, in a state that the corrected power ratio ε is maintained constant, test data is recorded while changing the recording power Pw and the erasing power Pe (the step ST4).

Then, the test data is reproduced and optimum recording power Pwopt and optimum erasing power Peopt are determined by the γ method.

Passing through the above procedures, the laser power optimizing process is completed. Then, recording of the user data will be performed by using the optimum recording power Pwopt and the optimum erasing power Peopt thus determined.

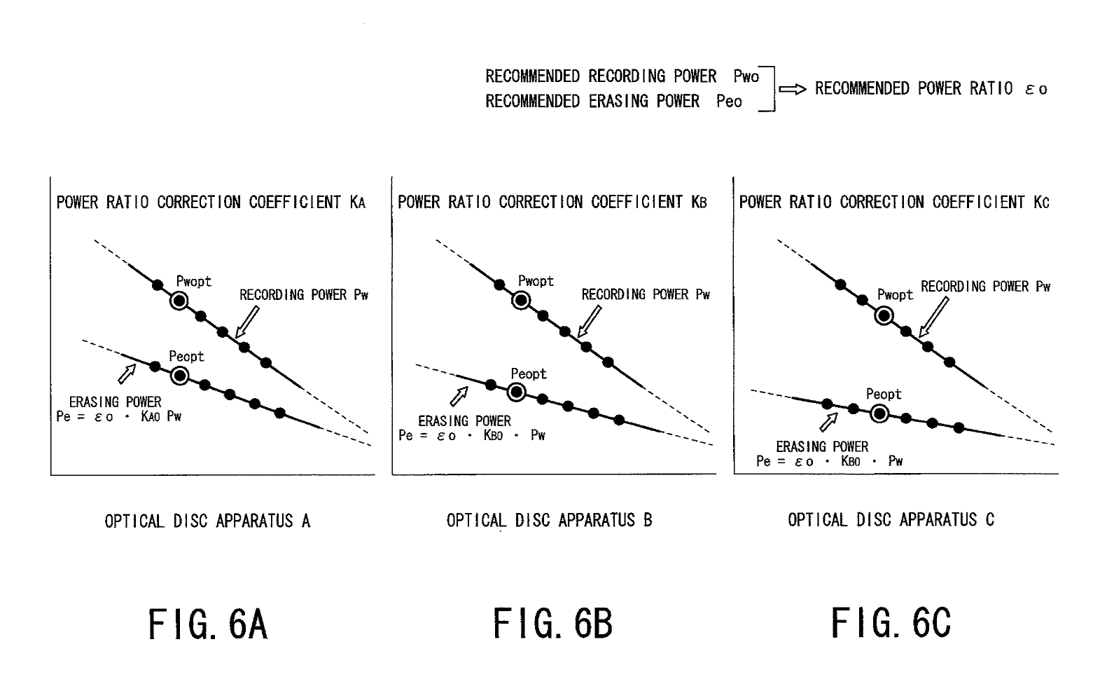

FIGS. 6A, 6B and 6C are diagrams showing examples in which the above mentioned laser power optimizing process is applied to three optical disc apparatuses 1 of different types (optical disc apparatuses A, B and C). In the nonvolatile memories 23 of the optical disc apparatuses A, B and C, correction coefficients K_{A}, K_{B} and K_{C} for the previously obtained power ratio are respectively stored. FIGS. 6A, 6B and 6C show examples in which the correction coefficients K_{A}, K_{B}, and K_{C} have values which are different from one another. With the correction coefficients K_{A}, K_{B} and K_{C} of different values, different power ratios are obtained. This means that, even if the inclinations at which recording powers Pw of these apparatuses change are the same as one another, the inclinations at which the erasing powers Pe relative to these recording powers change become different from one another. That is, even if, for example, the optical disc apparatuses A and B are the same as each other in the optimum recording power Pwopt, their optimum erasing powers Peopt have different values. This matter implies that even if the optical disc apparatuses A and B are different from each other in individual characteristic, there can be obtained the erasing power Peopt which is optimized for each of these apparatuses.

The correction coefficient Ko has been obtained, in advance, for each optical disc apparatus 1 in the course of manufacturing of these apparatuses. Next, a method of obtaining the correction coefficient will be described.

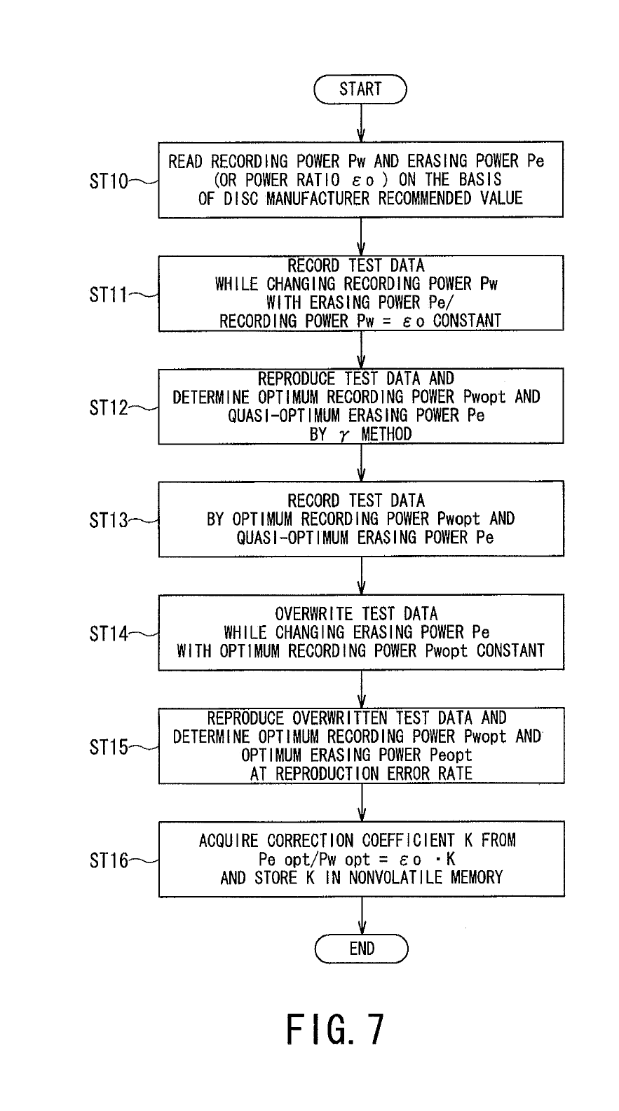

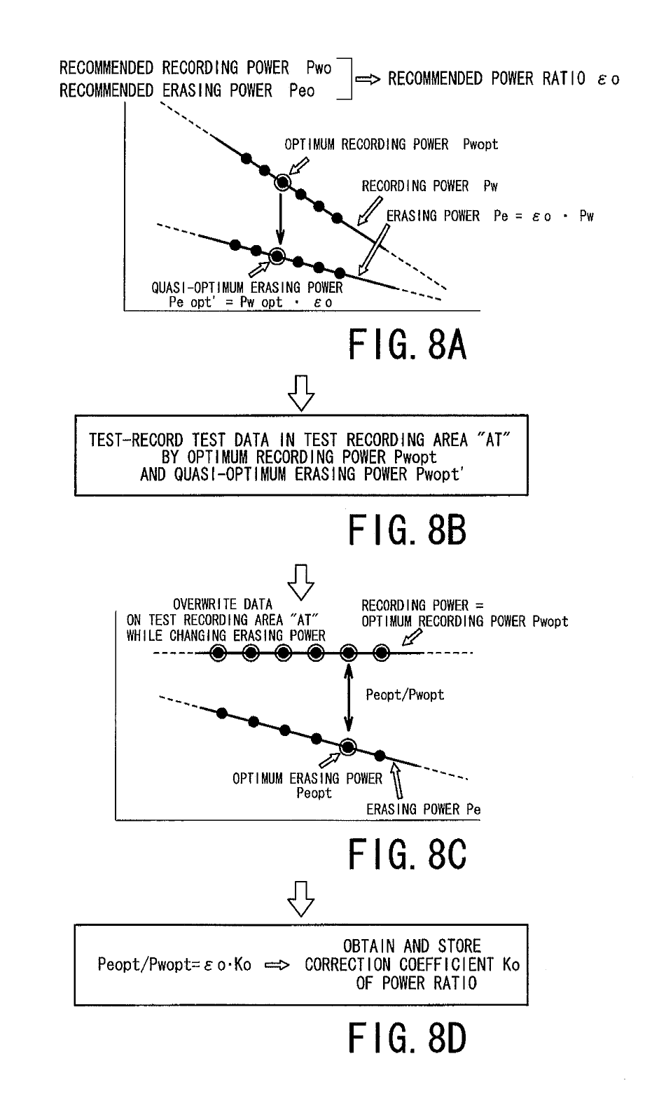

FIG. 7 is a flowchart showing an example of the method of obtaining the correction coefficient Ko and FIGS. 8A to 8D are illustrations thereof.

First, the optical disc 100 is inserted into the optical disc apparatus 1 to read out a recording power Pw and a erasing power Pe on the basis of disc manufacturer recommended values from a predetermined area of the optical disc 100. In a case that values of the recording power Pw and the erasing power Pe (or the recommended power ratio εo of Pe to Pw) have been already known because the name of the disc manufacturer concerned and the kind of the disc used are known, these values may be used (a step ST10).

Next, in a state that the ratio (the recommended power ratio εo) of the erasing power Pe to the recording power Pw is maintained constant, test data is recorded while changing stepwise the recording power Pw and the erasing power Pe (a step ST11). Then, the recorded test data is reproduced to determine an optimum erasing power Peopt and a erasing power Pe (a quasi-optimum erasing power Peopt′) corresponding to this optimum erasing power by the γ method (a step ST11).

The processes executed at the steps ST10, ST11 and ST12 are basically the same as those in the conventionally conducted general type OPC. FIG. 8A shows this state.

Next, by using the optimum recording power Pwopt and the quasi-optimum erasing power Peopt′ determined at the step ST11, the test data is again recorded (a step ST13 and FIG. 8B).

Further, in a state that the optimum recording power Pwopt is maintained constant, test data is overwritten on the recorded test data, while changing the erasing power Pe, for example, stepwise (a step ST14). FIG. 8C shows this state.

Then, the overwritten test data is reproduced and a reproduction error rate is estimated by the reproduced test data for each erasing power Pe which has been changed stepwise. After that, a erasing power which corresponds to the least reproduction error is determined as an optimum erasing power Peopt.

Finally, a correction coefficient Ko is acquired from a relation, Peopt/Pwopt=εo·Ko, and the acquired correction coefficient Ko is stored in the nonvolatile memory 23 (a step ST16 and FIG. 8D).

The correction coefficient Ko acquired in the above mentioned manner reflects the characteristics peculiar to each optical disc apparatus 1.

Incidentally, as described above, the characteristics peculiar to each apparatus, for example, the overshoot characteristic of its recording pulse wave form and the characteristic of its optical system change in accordance with a change in temperature. Thus, there can be obtained a more favorable correction coefficient, if these temperature-dependent changes in characteristic are reflected in the correction coefficient Ko.

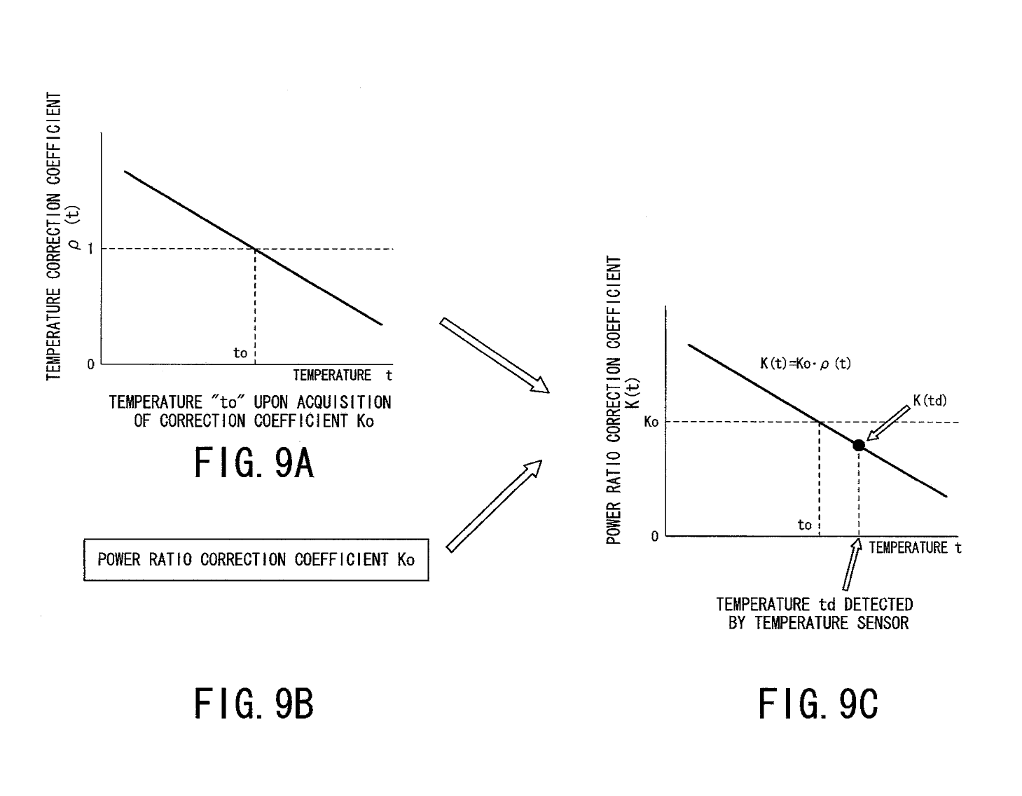

FIGS. 9A to 9C are diagrams illustrating a correction coefficient K(t) into which the temperature change is incorporated. In this embodiment, in addition to the above mentioned correction coefficient Ko, a temperature correction coefficient ρ (t) (see FIG. 9A) is obtained, in advance and then the correction coefficient k (t) into which the temperature change is incorporated is acquired from an equation K (t)=Ko·ρ (t) (see FIG. 9C). The correction coefficient Ko and the temperature correction coefficient ρ (t) may be respectively stored in the nonvolatile memory 23, or the product K (t) of the both may be stored in the nonvolatile memory 23. Here, the temperature correction coefficient ρ (t) is one in which, at a temperature “to” measured when the correction coefficient Ko has been obtained is defined, it shows a reference value (“1”). It may be expressed in the form of an appropriate approximate straight line (or an approximate curve) on the basis of the previously obtained temperature-change-dependent characteristic. Alternatively, the temperature correction coefficient ρ (t) may be tabled at appropriate temperature steps.

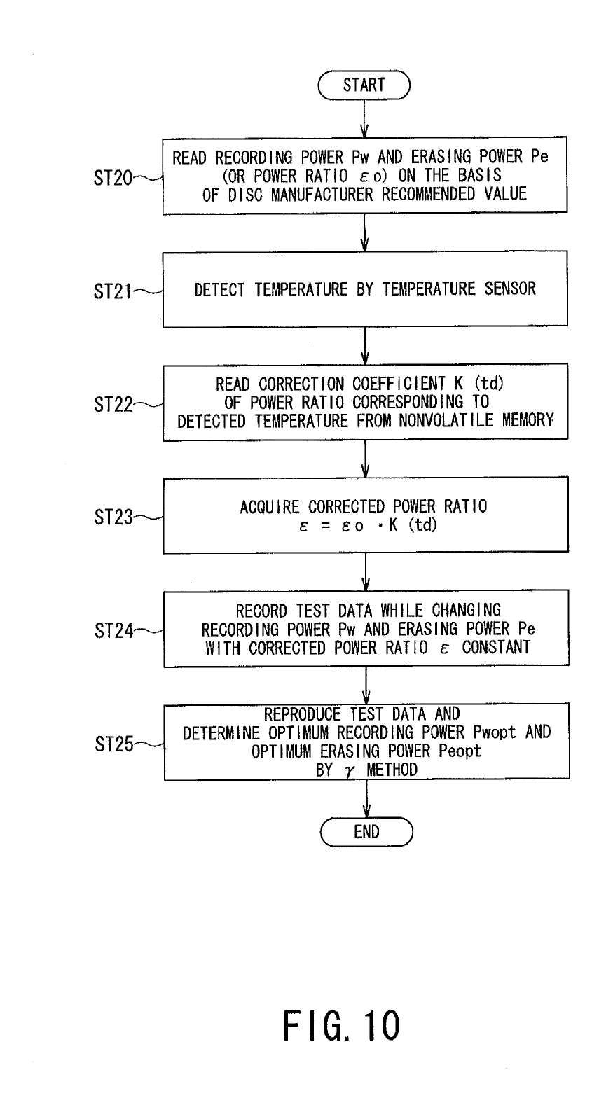

FIG. 10 is a flowchart showing an example of an optimizing process using the correction coefficient K (t). This process is the same as the above mentioned optimizing process (see FIG. 5) except that steps ST21 and ST22 are added. At the step ST21, a temperature td is detected by a temperature sensor 43 installed in the optical pickup 3 or the like. Then, at the step ST22, a correction coefficient K (td) of a power ratio corresponding to the detected temperature td is read out from the nonvolatile memory 23 (see FIG. 9C). The subsequent steps are the same as those in the above mentioned embodiment. That is, at a step ST23, a power ratio which has been corrected is obtained by an equation ε=εo·K (td). Then, in a state that the corrected power ratio ε is maintained constant, test data is recorded while changing the recoding power Pw and the erasing power Pe (a step ST24). Thereafter, the test data is reproduced to determine an optimum recording power Pwopt and an optimum erasing power Peopt by the γ method.

As described above, according to the optical disc apparatus 1 and the optical disc data recording method of the above mentioned embodiments, the laser power used upon the recording is optimized by using the correction coefficient Ko in which the characteristics peculiar to each optical disc apparatus are reflected. Therefore, there can be determined more accurate optimum recording power Pwopt and optimum erasing power Peopt than would be attained by the conventional OPC conducted on the basis of the power ratio εo recommended by the manufacturer of the optical disc concerned. In addition, their accuracies can be further increased by utilizing the correction coefficient K (td) which has been corrected in consideration of a change in temperature around the apparatus. As a result, it becomes possible to increase the number of allowed overwriting operations performed on the rewritable type optical disc and hence it becomes also possible to more increase the service life of the optical disc than would be possible in the case using the conventional OPC process.

Further, the correction coefficients Ko and K (td) have been obtained and stored, in advance, in the nonvolatile memory 23 in the course of manufacturing of each apparatus. Therefore, there is no need to repeat the test data recording and reproducing processes a plurality of times as in the technique disclosed in JP-A 2006-344251. Therefore, there can be obtained the optimum recording power Pwopt and the optimum erasing power Peopt in the short period of time which is almost the same as that attained by the conventional OPC.

It should be noted that the present invention is not explicitly limited to the above-mentioned embodiments, and the present invention can be embodied in the implementing stage by modifying the components without departing from the scope of the invention. Also, various embodiments of the invention can be formed by appropriately combining the disclosed components of the above-mentioned embodiments. For example, some of the components may be deleted from all of the disclosed components according to the embodiments. Furthermore, components from different embodiments may be appropriately combined.

What is claimed is:

1. An optical disc apparatus which performs data recording and reproduction on a rewritable type optical disc, the optical disc apparatus comprising:
an optical pickup configured to form marks and spaces on the optical disc by using a recording power and a erasing power respectively, thereby to record data and to reproduce the recorded data;
a control unit configured to write test data on trial on the optical disc while changing the recording power and the erasing power and to reproduce and evaluate the written test data, thereby to determine an optimum recording power and an optimum erasing power; and
a nonvolatile memory configured to store a correction coefficient which has been obtained in advance,
wherein the control unit corrects a power ratio of a recommended recording power to a recommended erasing power, these powers being assigned to each optical disc as recommended values, by the correction coefficient stored in the memory, and controls to write the test data on trial on the optical disc while changing the recording power and a erasing power, the erasing power being acquired from the recording power and the corrected power ratio.

2. The optical disc apparatus according to claim 1, further comprising a temperature sensor configured to detect the temperature of the optical disc apparatus,
wherein the correction coefficient includes a plurality of correction coefficients of which values differ at different temperatures, and
the control unit corrects the power ratio by one of the correction coefficients corresponding to the temperature detected by the temperature sensor.

3. The optical disc apparatus according to claim 1, wherein,
the correction coefficient is acquired, in the course of manufacturing of the optical disc apparatus, from the optimum recording power and the optimum erasing power, these optimum powers being obtained from a result of a trial writing process in which test data is written on trail for each optical disc apparatus while changing the recording power and the erasing power independently, and
the acquired correction coefficient is stored in the nonvolatile memory in the course of manufacturing of the optical disc apparatus.

4. An optical disc recording method of performing recording on a rewritable type optical disc, the method comprising the steps of:
(a) obtaining, in advance, a correction coefficient and storing the obtained correction coefficient;
(b) forming marks and spaces on the optical disc by using a recording power and a erasing power, thereby to record data on the optical disc, and reproducing the recorded data from the optical disc; and
(c) writing test data on trial on the optical disc while changing the recording power and the erasing power, and reproducing and evaluating the written test data to determine an optimum recording power and an optimum erasing power,
wherein the step (c) comprises;
correcting a power ratio of a recommended recording power to a recommended erasing power, these powers being assigned to each optical disc as recommended values, by the correction coefficient; and
controlling to write the test data on trial on the optical disc while changing the recording power and a erasing power, the erasing power being acquired from the recording power and the corrected power ratio.

5. The optical disc recording method according to claim 4, further comprising the step (d) of detecting the temperature of an optical disc apparatus,
wherein the correction coefficient includes a plurality of correction coefficients of which values differ at different temperatures, and
the step (c) further comprises correcting the power ratio by one of the correction coefficients corresponding to the detected temperature.

6. The optical disc recording method according to claim 4, wherein, in the step (a),
the correction coefficient is acquired, in the course of manufacturing of the optical disc apparatus, from the optimum recording power and the optimum erasing power, these optimum powers being obtained from a result of a trial writing process in which test data is written on trail for each optical disc apparatus while changing the recording power and the erasing power independently, and
the acquired correction coefficient is stored in a nonvolatile memory in the course of manufacturing of the optical disc apparatus.
